(19) United States
(12) Patent Application Publication
(10) Pub. No.: US 2003/0220137 A1
(43) Pub. Date: Nov. 27, 2003

(54) Method of awarding a bonus in a poker game and apparatus therefore

(76) Inventor: Gerald Duhamel, Drummondville (CA)

Correspondence Address: OGILVY RENAULT, 1981 MCGILL COLLEGE AVENUE, SUITE 1600, MONTREAL, QC, H3A2Y3, CA

(21) Appl. No.: 10/382,133

(22) Filed: Mar. 6, 2003

Related U.S. Application Data
(60) Provisional application No. 60/361,876, filed on Mar. 6, 2002.

(51) Int. Cl. A63F 13/00

(52) U.S. Cl. 463/25; 463/20

(57) ABSTRACT

The invention consists in a method and apparatus for awarding bonus payoffs depending on a plurality of game outcomes played independently from each other. Furthermore, with this method, the individual outcome values do not influence the bonus payoff. A typical embodiment of this method may be summarized for a poker game in: a) playing a first round to its outcome and keeping cards composing the outcome in a first array; b) playing a second round to its outcome and keeping cards composing the outcome in a second array; c) playing a third round of the game to its outcome and keeping cards composing the outcome in a third array; d) evaluating kept cards provided by said first, second and third outcomes according to at least one predetermined bonus configuration and based on a bonus pay schedule, wherein each said bonus configuration is composed of cards from at least two different outcomes; and e) awarding a bonus payoff according to said evaluation. The present method is open to a wide variety of games, of bet conditions and schemes, of additional criteria, etc. in order to provide a new incentive to the main game.

### CROSS-REFERENCE TO A RELATED APPLICATION

This application claims priority of U.S. provisional patent application serial No. 60/361,876, filed on Mar. 6, 2002 and entitled “Poker 3+”. The entire content of said provisional application is incorporated herein by reference.

### FIELD OF THE INVENTION

The invention relates to poker games and apparatuses for the play of such games. Furthermore, it relates to a method of providing an additional payoff according to a series of outcomes of such games.

### PRIOR ART

Poker games and apparatuses for the play of such games are well known. There are a lot of different poker games on the market differing from each other on the basis of rules, number of cards, pay schedules, betting schemes, bonus schemes, etc. According to players' preferences, some of these games are more popular than others.

Some of these games offer the option to players to play a plurality of rounds at once. According to the bet, the players can build a plurality of outcomes, which are evaluated to the determine prizes awarded. Examples of this strategy are U.S. Pat. No. 6,270,405 entitled “Casino Poker Game and Method” issued to Ferguson and U.S. Pat. No. 5,823,873 entitled “Method of Playing Electronic Video Poker Games” issued to Moody. According to these and similar methods, players see the number of hands built at once being increased. Nevertheless, the number of wins is not accordingly increased; wins are only available via a lower number of rounds.

U.S. Pat. No. 6,322,445 entitled “Multi-line Poker Video Gaming Apparatus and Method” issued to Miller describes a multi-line poker game with a game-hand line and a plurality of bonus lines that are combined to create a bonus array. Some cards from a round outcome are duplicated into a bonus array according to a random process. Based on a predetermined number of pay lines, the game outcome and the bonus array are evaluated regarding the presence of winning combinations based on a pay schedule. The player is awarded the corresponding prize. All the steps of this process are concentrated within a single round of the game.

Other prior art such as U.S. Pat. No. 5,639,088 entitled “Multiple Events Awarding System” issued to Schneider et al. describes a method of awarding bonus prizes based on a series of outcomes. These methods require players to accumulate a series of winning outcomes according to a predetermined criterion. Based on the number of outcomes needed to accomplish this task, the prize value varies.

Based on the current state of the art, it is our belief that there is a need for a method of awarding a bonus payoff in a poker game based on a series of outcomes, regardless of the individual values of such outcomes.

### OBJECTS OF THE INVENTION

Accordingly, one object of the invention is to provide a method of awarding bonus payoffs depending on a plurality of game outcomes.

Another object is to provide a method wherein the individual values of game outcomes will not strongly influence the value of a bonus outcome using these games outcomes. In consequence, the participation of a game outcome having a null value by itself in the evaluation of a plurality of game outcomes will not automatically results in a null-value bonus payoff. Moreover, the influence of such outcome will not influence the value of such bonus payoff.

Another object is to provide a method of awarding such bonus outcome that will not influence or weakly influence the player's strategy according to its choice.

Another object of the invention is to provide a method of awarding a bonus payoff that will not complicate the game, neither in its rules nor in its representation.

Another object is to provide a method that is adaptable to a variety of games, from draw and stud poker games to other games wherein a series of outcomes may be accumulated in order to evaluate a bonus-payoff.

### SUMMARY OF THE INVENTION

According to the above-objects, the invention consists in a method of evaluating a bonus payoff depending on a series of outcomes of a poker game. A typical application of the method comprises the following steps during the play of a draw poker:

a. playing a first round to its outcome and keeping game indicia composing the outcome in a first array;

b. playing a second round to its outcome and keeping game indicia composing the outcome in a second array;

c. playing a third round of the game to its outcome and keeping game indicia composing the outcome in a third array;

d. evaluating game indicia provided by said first, second and third outcomes according to at least one predetermined bonus configuration based on a bonus pay schedule, wherein each said bonus configuration is composed of game indicia from at least two different outcomes; and

e. awarding a bonus payoff according to said evaluation.

Therefore, the method requires storing a number of last-played outcomes in order to be evaluated for a bonus payoff. It also requires a determination of bonus configurations and a bonus pay schedule.

The method is not limited to draw poker; it can be applied to stud poker or other poker games regardless of their rules or bet schemes. Furthermore, the method is not limited to a video format; it can be applied to a live game wherein a plurality of rounds are played successively while keeping cards composing final outcomes on the table and wherein at the end of said plurality of rounds, the cards are evaluated regarding a bonus payoff.

In addition, the method may be applied to games that are not related to poker games without departing from its scope. The requisite for the game providing such outcomes is that such game outcomes can be provided as an array of game indicia of constant amount.

Furthermore, the betting option related to the method may vary. Players may be required to place a bet amount corresponding to a maximum bet value to be awarded bonus payoffs. Players may be required to place extra bets. Players may even change their bet amount from one round to another with or without resetting the outcomes kept for bonus evaluation. If changing a bet amount does not reset the bonus, the bonus payoff may be based on the lowest bet amount according to the outcomes evaluated for the bonus payoff.

### FIGURES

These and other aspects and advantages of the present invention will become better understood in light of the following detailed description of preferred embodiments with reference to the accompanying drawings, in which:

FIG. 1 is a schematic illustration of regular and bonus configurations of outcomes according to the preferred embodiment;

FIG. 2 is an example of a bonus pay schedule according to the same embodiment;

FIGS. 3a through 3h illustrate a sequence of play;

FIG. 4 illustrates via a flow chart the steps of playing a series of round to a bonus evaluation; and

FIG. 5 is a block diagram that illustrates the components of a gaming machine fulfilling the present method.

### PREFERRED EMBODIMENT

The preferred environment is a draw poker game in a video format via an electronic gaming machine, which gaming environment is well known in the art.

In its preferred embodiment, three (3) game outcomes are combined. The result duplicates a 5-reel slot-machine display: three (3) lines of five (5) game indicia that can be analyzed just like symbols of a slot machine. In this case, the bonus configuration includes two combinations of indicia that are analyzed: an upward V-shaped bonus line 4 and a downward V-shaped bonus line 5, illustrated on FIG. 1. The three horizontal lines (1, 2, and 3) correspond to round outcomes as played. According to the current embodiment, the bonus lines are analyzed according to a bonus pay schedule using standard poker criteria. Any other criteria may be used.

The game process for a draw poker may be summarized by in the following steps. After placing a first wager, the player is dealt five (5) cards. The player discards as many cards as he desires and new cards are dealt from the same deck. The resulting outcome is compared to a poker pay schedule and the player receives the corresponding payoff. Game indicia composing this outcome are then displayed in the top array; this array is on the upper part of the game area. If the player desires to play again, he places a second wager and receives a new hand of cards coming from a new card deck. The round is played to its outcome. This outcome is then analyzed and a corresponding payout is awarded to the player. Game indicia composing this second outcome are displayed in the middle array. When a third wager has been placed, a third hand, coming from a new deck, is dealt. This third hand is also played and analyzed to award the corresponding payoff.

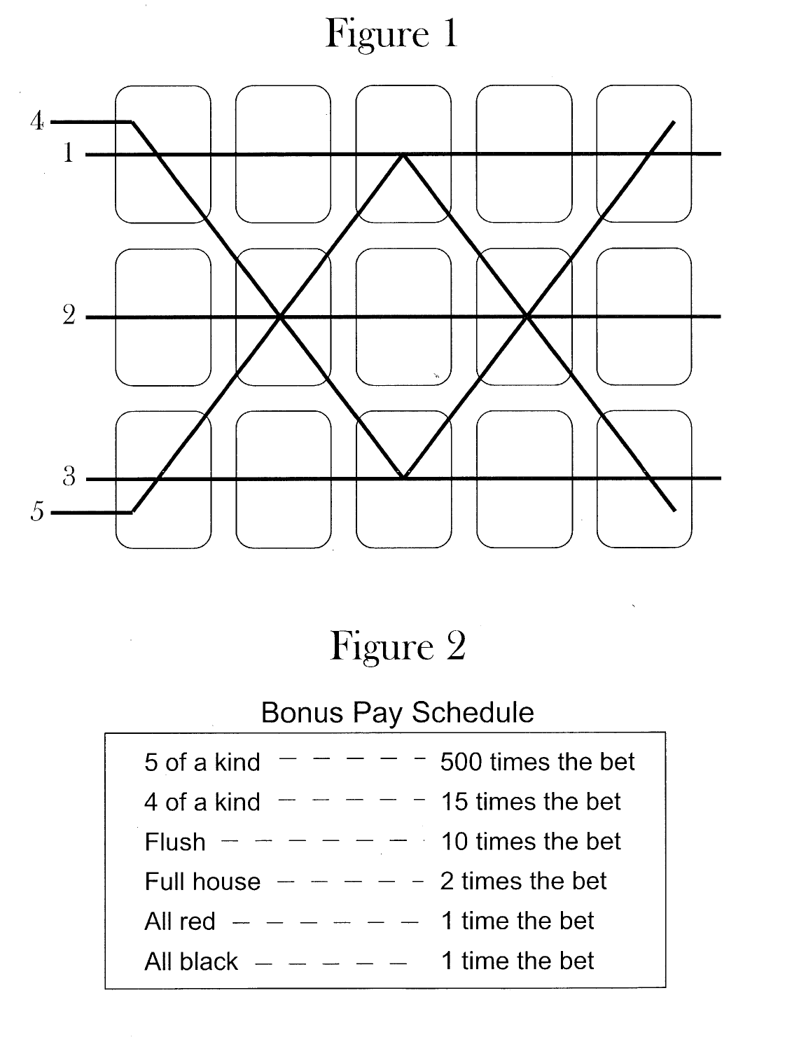

Then, the game enters in the bonus evaluation process. The game indicia composing all outcomes are used as elements of a 5-lines slot-machine game wherein only the upward V-shaped bonus line 4 and a downward V-shaped bonus line 5 are analyzed. A bonus payoff is awarded when the player gets a winning bonus outcome according to a bonus pay schedule; winning criteria may be standard poker criteria or special criteria. An example of such bonus pay schedule is provided in FIG. 2.

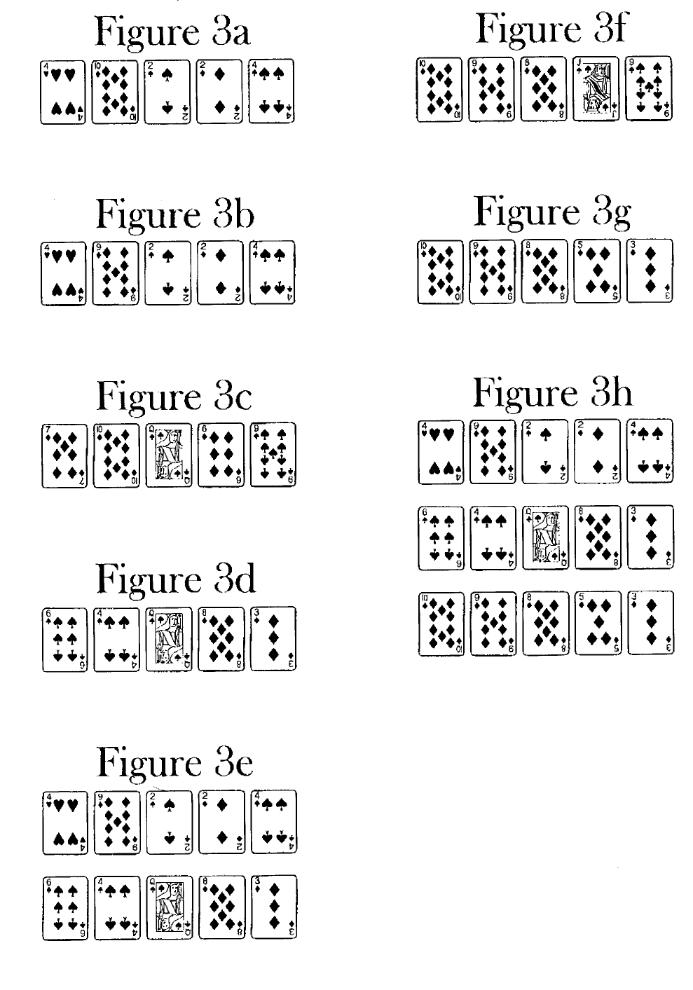

To offer a better understanding, a particular sequence of play is illustrated in FIGS. 3a through 3h.

At the start of the play sequence, no outcome is available. The initial hand dealt is composed of cards as illustrated on FIG. 3a. The player discards the Ten of Diamond and gets a first outcome, illustrated on FIG. 3b. He is awarded the prize corresponding to a Two Pairs outcome according to the poker pay schedule. This final outcome is kept in the top array, FIG. 1—line 1). The player places a second bet and he is dealt a new initial hand, see FIG. 3c. He discards all cards except for the Queen of Spade and gets a second outcome, illustrated on FIG. 3d. This outcome does not correspond to any winning outcome in the poker pay schedule. The second outcome is kept in the center array, FIG. 1—line 2. The game representation now looks somewhat like the illustration on FIG. 3e. The player places a third bet. He is dealt a new hand of cards, see FIG. 3f. The player discards the Jack and Nine of Spade. His third outcome results as the illustration on FIG. 3g. The player gets a Flush and is awarded the corresponding prize. According to this third outcome, the game representation displays three arrays filled of game indicia as illustrated on FIG. 3h. The bonus pay schedule (FIG. 2) is then applied according to bonus lines 4 and 5. The player is awarded a bonus payoff corresponding to a Full house for the upward V-shaped bonus line 4 and nothing for the bonus line 5.

Other alternatives exist within the scope of the invention. For instance:

i. Win/Lose Bonus Pay Schedule: The bonus lines are analyzed only on the basis of win and loss statuses. If a bonus line corresponds to a winning outcome in a classic poker game, it is marked as a Win, if not, it is marked as a Loss. The player is awarded a prize based on his number of Wins.

ii. Slot-like Bonus Pay Schedule: Evaluation according to the bonus pay schedule considers cards as symbols, regardless of any standard poker outcome analysis. With this bonus pay schedule, a player can be awarded the occurrence of two Four of Spade on the same bonus line, but two Fours, two Spades, or black cards on the bonus line either or not in sequence for instance.

iii. Outcome Single-Bonus Use: After the three outcomes are analyzed and the bonus payoff is awarded, the three outcomes disappear before a new play begins.

iv. Sequential Outcome Use: All outcomes are kept and a new outcome pushes the oldest one out of the game. In consequence, outcomes may participate in a plurality of bonus payoffs.

v. Losses Bonus Participation: Only regular outcomes evaluated as losses participate in bonus payoffs; other outcomes either are simply rejected or reset array information previously gathered.

vi. Side Bet Requirement: Players may need to place a side bet or an additional bet to see their outcomes evaluated as bonus payoffs.

vii. Bonus Payoff Fixing Method: Bonus payoffs may be based on the smallest bet placed by the player on participating outcomes. Accordingly, if a player modifies his bet during a play sequence, bonus payoffs refer to the smallest bet. For instance, a bet modification of 3-5-4 coins would allow bonus evaluation based on a 3-coin bet. An alternative is to reset the bonus according to a bet reduction for instance.

viii. Original Game: The game providing outcomes may vary from draw poker, stud poker, dice game, etc. The requirement is to provide fixed-size outcomes; therefore with an unvarying number of game indicia.

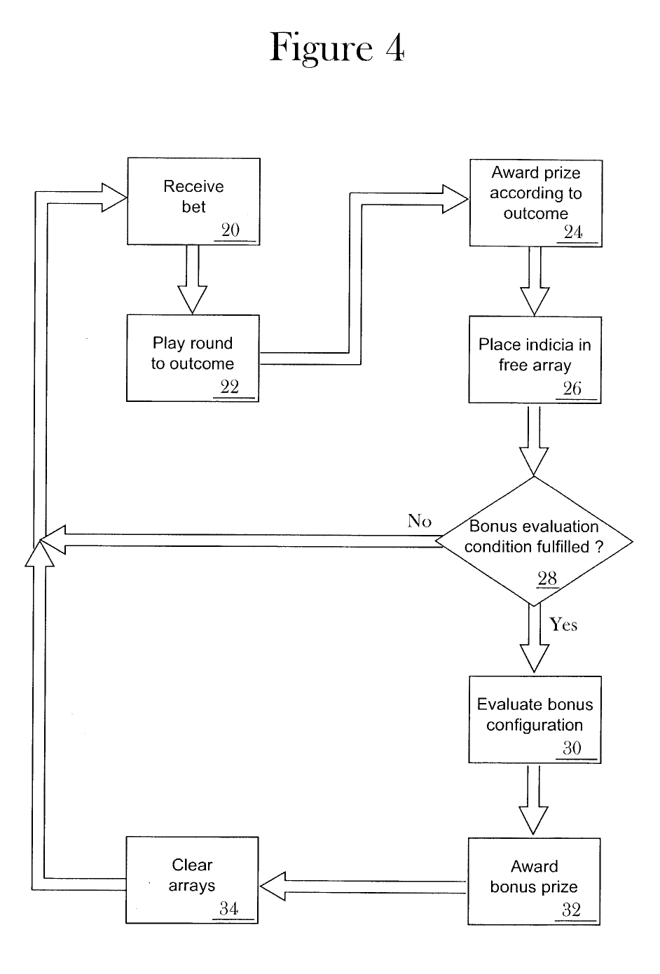

FIG. 4 illustrates via a flow chart the steps to play a series of rounds on an electronic gaming machine according to this method. First, the player inserts credits into the machine and places a bet 20. It allows the player to play a round to its outcome 22, which may results into a prize 24. Then, the game indicia composing the outcome are placed into an array 26 on top of the screen; it is the beginning of the accumulation of indicia for the bonus. The machine verifies if the requisite number of game indicia/outcomes is gathered for a bonus evaluation 28. In the case of a negative evaluation, the steps 20, 22, 24 and 26 are repeated until the condition is fulfilled. Then, the machine evaluates the game indicia based on a series of bonus configurations 26, which may result for the player into one or more bonus prizes 32. When the bonus evaluation is completed, the arrays used to accumulate game indicia are cleared 34; which state starts a whole new bonus process.

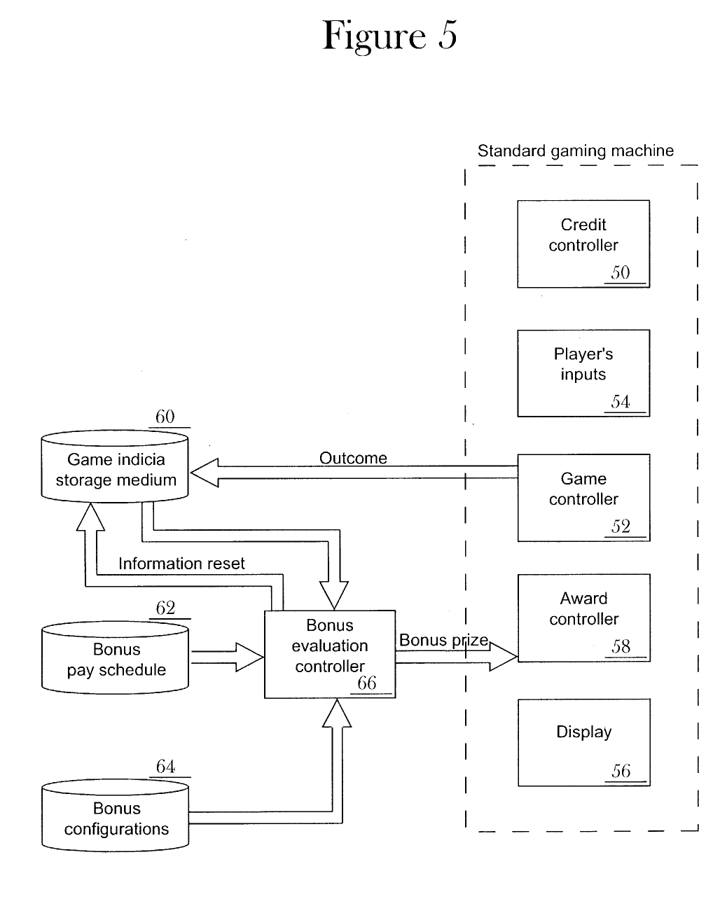

FIG. 5 illustrates the components of a gaming machine fulfilling the present method. Typical gaming machines include a credit controller 50 managing credit insertions and the player's account; a game controller 52 generating requisite game information for the play of a round to its outcome; player's inputs 54 which are controls allowing the player to interact with the game; a display 56 providing a graphical interface and specifically a game representation; and an award controller evaluating round outcomes and determining prizes accordingly. Furthermore, the present machine includes a game indicia storage medium 60 in which game indicia are placed for a bonus evaluation; bonus pay schedule 62 and bonus configurations 64; and a bonus evaluation controller 66 which uses information from the game indicia storage medium 60, the bonus pay schedule 62 and the bonus configurations 64 to determine if a bonus condition is fulfilled, to determine the bonus to pay, and to order a reset of the game indicia storage medium once the bonus evaluation has been done.

Accordingly, while the invention has been described in connection with the specific embodiments thereof, it will be understood that it is capable of further modifications. It is the intent to cover any variations, uses, or adaptations of the invention following, in general, the principles of the invention and including such departures from the present disclosure as come within known or customary practice within the art to which the invention pertains. These applications will find their essential features herein set forth in the scope of the appended claims.

1. A method of calculating a bonus payoff based on a series of independently played outcomes of a wagering game and wherein said series of outcomes being composed of at least two outcomes, said method comprising steps of:
determining a bonus pay schedule;
determining at least one bonus configuration, wherein each bonus configuration consists in a combination of game indicia involving at least two outcomes;
storing all game indicia from said at least two outcomes in arrays, wherein one array of game indicia contains all game indicia composing a single outcome;
evaluating a bonus payoff based on said bonus configuration; and
awarding evaluated bonus payoff to a player.

2. The method of claim 1, further comprising steps of:
monitoring outcome in order to determine a participation status, wherein said participation status determines whether an outcome is stored in an array in order to participate in a bonus payoff; and
storing all game indicia from an outcome with a positive participation status while not storing game indicia from an outcome with a negative participation status.

3. The method of claim 2, further comprising step of resetting array information in response to an outcome with a negative participation status.

4. The method of claim 1, further comprising step of monitoring a player's bet versus a predetermined bet level, wherein said player's bet reaching said predetermined bet level activates said storing step, while a player's bet under said predetermined bet level avoids said storing step.

5. The method of claim 1, wherein said wagering game is depending on strategy to be played to a final outcome.

6. The method of claim 1, wherein said game is poker.

7. The method of claim 1, further comprising step of freeing one array from game indicia information in response to the occurrence of a new outcome and storing all game indicia of said new outcome in one array.

8. The method of claim 1, wherein number of outcomes required to evaluate a bonus payoff is three (3).

9. The method of claim 1, wherein number of bonus configurations is between two (2) and four (4).

10. The method of claim 1, further comprising steps of:
monitoring player's bet level to play wagering game;
identifying lowest player's bet level within outcomes participating in bonus payoff evaluation; and
determining a bonus pay schedule based on said lowest player's bet level to award said bonus payoff.

11. The method of claim 1, wherein number of game indicia composing outcome is identical for all said outcomes.

12. The method of claim 11, wherein said number of game indicia is five (5).

13. The method of claim 1, wherein said wagering game is a dice game.

14. A gaming apparatus for the play of a wagering game wherein a bonus payoff is calculated on the basis of a series of independently played outcomes of said wagering game, said gaming apparatus comprising:
credit input means recording player's inserted credits;
player input means receiving player's actions to input information into said game;
game controller generating a game round to an outcome;
outcome storing medium recording game indicia composing outcomes, with game indicia of each outcome being stored in a single array of said outcome storage medium;
single outcome evaluation means evaluating individual said outcomes in order to determine an associated outcome payoff;
bonus evaluation controller determining a bonus payoff value based on game indicia provided by said outcome storage medium, bonus pay schedule and at least one bonus configuration, wherein each said bonus configuration consists in a combination of game indicia involving at least two outcomes;
a display; and
payout means awarding calculated payoffs to players, wherein said payoffs are single outcome payoffs and bonus payoffs.

15. The apparatus of claim 14, further comprising an outcome participation controller determining if game indicia composing an outcome are stored on said outcome storing medium, whereby not storing game indicia from an outcome results in avoiding bonus participation of said outcome.

16. The apparatus of claim 14, further comprising a bet-level monitoring controller monitoring bet levels placed on said series of independently played outcomes and modifying bonus payoffs according to monitored bet levels.

17. The apparatus of claim 14, further comprising an additional display for storing game indicia provided by last-played outcomes participating in current bonus payoff.

18. A method of calculating a bonus payoff based on a series of independently played outcomes of poker, wherein said series of outcomes is evaluated according to at least one bonus configuration, said method comprising steps of:
determining a bonus pay schedule;
determining at least one bonus configuration, wherein each bonus configuration consists in a combination of game indicia involving at least two outcomes;
storing all game indicia from at least three outcomes in arrays, wherein one array of game indicia contains all game indicia composing a single outcome;
evaluating a bonus payoff on the basis of bonus pay schedule and said at least one bonus configuration; and
awarding evaluated bonus payoff to a player.

19. A method of calculating a bonus prize based on a series of independently played outcomes of a wagering game, wherein said series of outcomes is evaluated according to at least one bonus configuration, said method comprising steps of:
a) receiving a bet from a player;
b) providing opportunity to said player to play a round to its outcome;
c) awarding said player a prize based on a single-outcome pay schedule according to said bet and said outcome;
d) storing game indicia composing said outcome in a free array;
e) verifying whether a bonus-evaluation condition is fulfilled, where a negative evaluation triggers a repetition of steps a) trough d) while a positive evaluation triggers completion of step f);
f) evaluating stored game indicia based on a bonus pay schedule and at last one bonus configuration, wherein each bonus configuration consists in a combination of game indicia involving at least two outcomes; and
g) awarding said player a bonus prize.

20. The method of claim 19, further comprising step h) of clearing said arrays after step g) of awarding said player a bonus prize.

21. The method of claim 19, further comprising between steps b) and d) steps of:
i) monitoring outcome in order to determine a participation status, wherein said participation status determines if game indicia composing said outcome are stored in an array in order to participate in a bonus payoff evaluation; and
ii) storing all game indicia provided by an outcome with a positive participation status while not storing game indicia provided by an outcome with a negative participation status.

22. The method of claim 19, wherein steps are completed in described order.
